(19) United States
(12) Patent Application Publication
(10) Pub. No.: US 2025/0182369 A1
(43) Pub. Date: Jun. 5, 2025

(54) Use Color Information in 3D Surface Matcher

(71) Applicant: ZEBRA TECHNOLOGIES CORPORATION, Lincolnshire, IL (US)

(72) Inventor: Ola El Bakry, Dollard-Des-Ormeaux (CA)

(21) Appl. No.: 18/526,394

(22) Filed: Dec. 1, 2023

(51) Int. Cl. G06T 15/00; G06T 5/40; G06T 7/90; G06V 10/56; G06V 10/74

(52) U.S. Cl. CPC G06T 15/00; G06T 5/40; G06T 7/90; G06V 10/56; G06V 10/761; G06T 2207/10024

(57) ABSTRACT

Systems and methods for performing surface matching using three-dimensional (3D) and color information. An example method includes obtaining, by a 3D camera, a first 3D image of a field of view. The 3D image includes (i) a plurality of voxels, or 3D points, of the field of view and (ii) color information of the field of view. A processor normalizes the color information into a common color space, and determines scene histograms from the normalized color information. Each of the scene histograms is determined for a voxel of the plurality of voxels. The method further includes determining a color score from at least the scene histograms and model histograms, the model histograms being indicative of color information of a model image of a 3D object, and determining the presence of a surface of an object in the first 3D image from the color score.

### BACKGROUND

Machine vision technologies provide a means for image-based inspection and analysis for applications ranging from automatic part inspection, process control, robotic guidance, part identification, barcode reading, and many others. Machine vision technologies rely on capturing and processing images for performing specific analysis or tasks which often require both the integrated use of imaging systems as well as processing systems.

Industrial machine vision (IMV) may be useful for monitoring and classifying inventory in a warehouse, along a production line, or at a receiving bay. Therefore, a means for identifying parts and products for IMV is necessary. Surface matching systems may utilize machine vision processes for identifying different surfaces of an object for identifying objects, performing fabrication evaluations, etc. Current surface matchers only use geometric shapes of models to detect similar geometric occurrences to perform surface matching. As such, surface matchers may identify similar surfaces, or surfaces of larger objects, that are not actually matches for a given object or surface. As such, after a surface is identified as a match, a user may be required to further verify that the object is an actual match which increases the overall time of the matching process. Due to the potentially high error rates of surface matching technologies, the use of surface matching can be limited to very specific applications and environments.

As such, it could be beneficial for a surface matching system that is efficient and highly successful at identifying surfaces among a plurality of various surfaces and objects.

Accordingly, there is a need for improved designs having improved functionalities.

### SUMMARY

In an embodiment, the present invention is a method for performing three-dimensional surface matching. The method includes obtaining, by a three-dimensional (3D) camera, a first 3D image or a 3D point cloud of a field of view of the 3D camera, the 3D image or point cloud including (i) a plurality of voxels, or a plurality of 3D points, of the field of view and (ii) color information of the field of view; normalizing, via a processor, the color information into a common color space; determining, via the processor, scene histograms from the normalized color information of the first 3D image, each of the scene histograms determined for a voxel of the plurality of voxels of the first 3D image; determining, via the processor, a color score from at least the scene histograms and model histograms, the model histograms being indicative of color information of a model image of a 3D object; and determining, via the processor, the presence of a surface of an object in the first 3D image from the color score.

In variations of the current embodiment, normalizing the first 3D image into a common color space includes converting the first 3D image into lab color space or hue, saturation, lightness (HSL) color space.

In continued variations of the current embodiment, determining the color score includes identifying, via the processor, sets of corresponding voxels between the voxels of the first 3D image, and voxels of the model image; determining, via the processor, a comparison score for each set of corresponding voxels; and determining, via the processor, the color score as a weighted sum of the comparison scores.

In more variations of the current embodiment, the method further includes obtaining, by a 3D camera, a second 3D image of a model object, the second 3D image including (i) 3D spatial information of the model object and (ii) color information associated with the model object; normalizing, via a processor, the color information associated with the model object into a common color space; determining, via the processor, voxels of the second 3D image from the 3D spatial information of the model object; determining, via the processor, the model color histograms from the voxels of the second 3D image and the normalized color information associated with the model object.

In yet more variation of the current embodiment, the method further includes determining, via the processor, 3D information pertaining to one or more surfaces of the object in the first 3D image. In even more variations of the current embodiment, the method further includes determining, via the processor, one or more normal vectors of the surface of the object in the first 3D image.

In another embodiment, the present invention is a system for performing surface matching. The system includes a 3D imager configured to capture and provide 3D images of a field of view of the color imager, the 3D images including (i) a plurality of voxels, or a plurality of 3D points, of the field of view and (ii) color information of the field of view; and a processor and computer-readable media storage having machine readable instructions stored thereon that, when the machine readable instructions are executed, cause the system to: obtain a first 3D image of the field of view of the 3D camera; normalize color information of the first 3D image into a common color space; determine scene histograms from the normalized color information of the first 3D image, each of the scene color histograms determined for a voxel in the first 3D image; determine a color score from at least the scene histograms and model histograms, the model histograms being indicative of color information of a model image of a 3D object; and determine the presence of a surface of an object in the first 3D image from the color score.

In variations of the current embodiment, to normalize the color information into a common color space, the machine readable instructions further cause the system to convert the color information of the first 3D image into lab color space or hue, saturation, lightness (HSL) color space.

In more variations of the current embodiment, to determine the color score, the machine readable instructions further cause the system to: identify sets of corresponding voxels between the voxels of the first 3D image, and voxels of the model image; determine a comparison score for each set of corresponding voxels; and determine the color score as a weighted sum of the comparison scores.

In continued variations of the current embodiment, the machine readable instructions further cause the system to: obtain a second 3D image of a model object, the second 3D image including (i) 3D spatial information of the model object and (ii) color information associated with the model object; normalize the color information associated with the model object into a common color space; determine voxels of the second 3D image from the 3D spatial information of the model object; determine the model histograms from the voxels of the second 3D image and the normalized color information associated with the model object.

In yet another embodiment, the present invention is one or more non-transitory computer-readable media storing computer-executable instructions that, when executed via one or more processors, cause one or more imaging systems to: obtain, via a 3D camera, a first 3D image of a field of view of the 3D camera, the first 3D image including (i) 3D spatial information and (ii) color information of the field of view; normalize, via a processor, the color information into a common color space to form normalized color information; determine, via the processor, scene color histograms from the normalized color information of the first 3D image, each of the scene color histograms determined for a voxel in the first 3D image; determine, via the processor, a color score from at least the scene color histograms and model color histograms, the model color histograms being indicative of color information of a model image of a three-dimensional object; and determine, via the processor, the presence of a surface of an object in the first 3D image from the color score.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an example imaging system configured to analyze an image of a target object to execute a machine vision job, and more specifically, a surface matching job in accordance with various embodiments disclosed herein.

FIG. 2 is a perspective view of the imaging device of FIG. 1, in accordance with embodiments described herein.

FIG. 3 illustrates an example environment for performing machine vision scanning, and surface matching, of an object, in accordance with embodiments described herein.

FIG. 4 illustrates a flowchart for a method of performing 3D surface matching using color information, in accordance with embodiments described herein.

FIG. 5 illustrates a flowchart of another method for performing 3D surface matching using geometric and color information, in accordance with embodiments described herein.

FIG. 6A is a camera image of a model object being a cutter for demonstrating performing 3D surface matching using geometric and color information, in accordance with embodiments described herein.

FIG. 6B is an image captured by a 3D surface matching system of model object for performing surface matching without utilizing color information.

FIG. 6C is an image showing a 3D model of the model object of FIGS. 6A and 6B, for performing surface matching without using color information.

FIG. 6D is an image illustrative of performing surface matching on multiple objects without using color information, showing multiple erroneous surface matches.

FIG. 7A is an image of a model object for performing surface matching utilizing color information, in accordance with embodiments described herein.

FIG. 7B is an image of a 3D geometric model of the model object of FIG. 7A for performing surface matching utilizing color information, in accordance with embodiments described herein.

FIG. 7C is an image of surfaces matched to the model surface of FIG. 7A using the 3D geometric model of FIG. 7B, and associated color information, in accordance with embodiments described herein.

FIG. 8A is an image of a model surface of a fish with a given color distribution for performing surface matching, in accordance with embodiments described herein.

FIG. 8B is an image of a plurality of fish with similar or same geometric information as the model surface of FIG. 8A for performing surface matching, in accordance with embodiments described herein.

FIG. 8C is an image of a surface matching operation that does not utilize color information for matching surfaces with the model surface of FIG. 8A.

FIG. 8D is an image of a surface matching operation that includes using color information in matching surfaces with the model surface of FIG. 8A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Machine vision systems used for surface matching utilize three-dimensional (3D) information obtained via images or point clouds to identify surfaces of objects. Typically, these systems only use geometric information or shapes of objects in an image to match the object surface to geometric patterns or properties of a geometric model surface or object. Some applications of surface matching and object identification may require the system to determine between two different objects with a same or similar surfaces. For example, two soda cans of different types of soda may have nearly identical surfaces and geometric properties. In such examples, a typical surface matching system is unable to discern between the different objects or surfaces. Additionally, as will be demonstrated further herein, some larger objects may include surfaces with similar geometric properties as some smaller components or objects. Systems that only include geometry for surface matching can erroneously identify multiple objects and surfaces which further require a user or operator to intervene and further affirm or reject the system surface identification.

As described herein, the embodiments of the present disclosure may provide for more robust machine vision surface matching and object identification for various applications. By utilizing both 3D geometric information and color information of a surface, the described systems and methods are capable of performing surface matching with increased efficiency and reduced error rates. Additionally, the surface matching utilizing color information described herein may be used to further distinguish between various products that have same or similar geometric surfaces and containers, as will be demonstrated and illustrated in the figures and associated descriptions further herein. The disclosed embodiments may further provide benefits as to reduce human analysis and input during automated processes, increase surface matching efficiency, increased object identification efficiency and accuracy, and increase the versatility, machine vision process efficiency, and robustness of a machine vision system, and specifically, of a surface matching system.

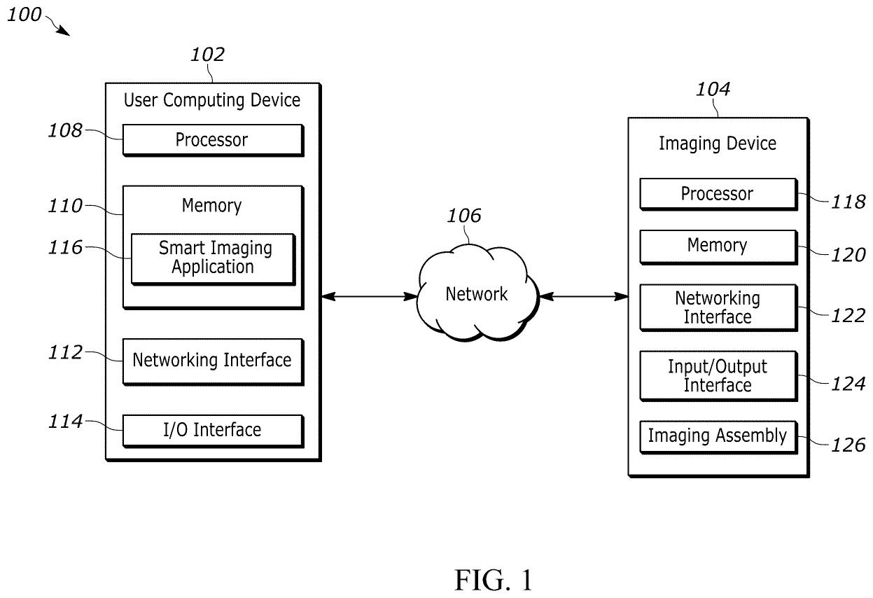

FIG. 1 illustrates an example imaging system 100 configured to analyze an image of a target object to execute a machine vision job, and more specifically, a surface matching job in accordance with various embodiments disclosed herein. More specifically, the imaging system 100 is configured to detect and identify indicia in a plurality of orientations and arrangements in an image. In the example embodiment of FIG. 1, the imaging system 100 includes a user computing device 102 and an imaging device 104 communicatively coupled to the user computing device 102 via a network 106. Generally speaking, the user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision job, such as a surface matching job, for execution on the imaging device 104. When created, the user/operator may then transmit/upload the machine vision job to the imaging device 104 via the network 106, where the machine vision job is then interpreted and executed. The user computing device 102 may comprise one or more operator workstations, and may include one or more processors 108, one or more memories 110, a networking interface 112, an input/output (I/O) interface 114, and a smart imaging application 116.

The imaging device 104 is connected to the user computing device 102 via a network 106, and is configured to interpret and execute machine vision jobs and/or various surface matching and object matching jobs, received from the user computing device 102. Generally, the imaging device 104 may obtain a job file containing one or more job scripts from the user computing device 102 across the network 106 that may define the machine vision job and may configure the imaging device 104 to capture and/or analyze images in accordance with the machine vision job. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more job scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically perform sufficient functionality of the imaging device 104 in order to obtain, interpret, and execute job scripts that define machine vision jobs, such as any one or more job scripts contained in one or more job files as obtained, for example, from the user computing device 102.

Broadly, the job file may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 from the user computing device 102. Additionally or alternatively, the server configured to listen for and receive job files may be implemented as one or more cloud-based servers, such as a cloud-based computing platform. For example, the server may be any one or more cloud-based platform(s) such as MICROSOFT AZURE, AMAZON AWS, or the like.

In any event, the imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data, vector information, or other image data that may be analyzed by one or more tools each configured to perform an image analysis task. The digital camera and/or digital video camera of, e.g., the imaging assembly 126 may be configured, as disclosed herein, to take, capture, obtain, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly may additionally include a three-dimensional (3D) camera (not shown) for capturing, sensing, or scanning 3D image data. The 3D camera may include an Infra-Red (IR) projector and a related IR camera for capturing, sensing, or scanning 3D image data/datasets. A 3D camera of the imaging assembly 126 may include one or more of a time-of-flight camera, a stereo vision camera, a structured light camera, a range camera, a 3D profile sensor, or a triangulation 3D imager. In any embodiments, the imaging assembly includes a camera capable of capturing color information of a field of view (FOV) of the camera. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data. In examples, a 3D image may include a point cloud or 3D point cloud. As such, as used herein, the terms 3D image and point cloud or 3D point cloud may be understood to be interchangeable.

In embodiments, the imaging assembly 126 may be configured to capture images of surfaces or areas of a predefined search space or target objects within the predefined search space. For example, each tool included in a job script may additionally include a region of interest (ROI) corresponding to a specific region or a target object imaged by the imaging assembly 126. The ROI may be a predefined ROI, or the ROI may be determined through analysis of the image by the processor 118. Further, a plurality of ROIs may be predefined or determined through image processing. The composite area defined by the ROIs for all tools included in a particular job script may thereby define the predefined search space which the imaging assembly 126 may capture in order to facilitate the execution of the job script. However, the predefined search space may be user-specified to include a FOV featuring more or less than the composite area defined by the ROIs of all tools included in the particular job script. It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data. Further, one or more ROIs may be within a FOV of the imaging system such that any region of the FOV of the imaging system may be a ROI.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the smart imaging application 116 for viewing, manipulation, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., smart imaging application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store the smart imaging application 116, which may be configured to enable machine vision job construction, as described further herein. Additionally, or alternatively, the smart imaging application 116 may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the smart imaging application 116, where each may be configured to facilitate their various functionalities discussed herein. It should be appreciated that one or more other applications may be envisioned and that are executed by the one or more processors.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 in order to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision job images (e.g., images captured by the imaging device 104 in response to execution of a job script) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, objects, surfaces, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct jobs, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

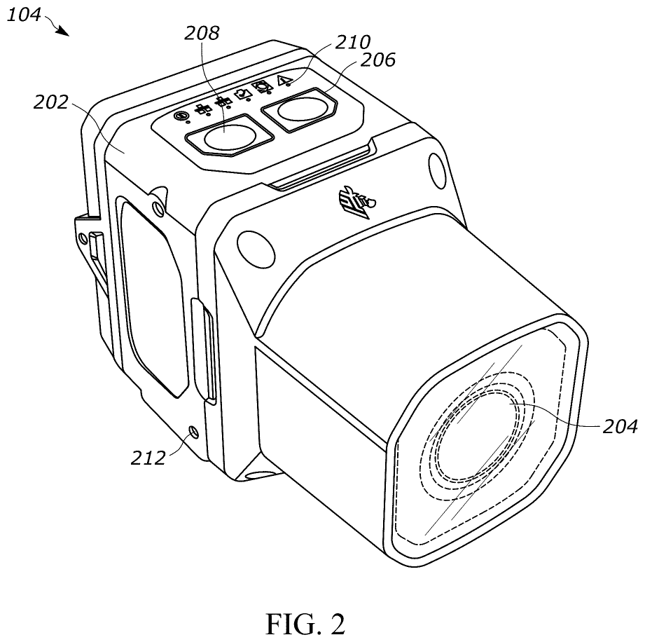

FIG. 2 is a perspective view of an example imaging device 104 that may be implemented in the imaging system 100 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., user computing device 102) which the imaging device 104 thereafter interprets and executes. The instructions included in the job file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 204. As an example, assume that at least a portion of the intended analysis corresponding to a machine vision job requires the imaging device 104 to maximize the brightness of any captured image. To accommodate this requirement, the job file may include device configuration settings to increase the aperture size of the imaging aperture 204. The imaging device 104 may interpret these instructions (e.g., via one or more processors 118) and accordingly increase the aperture size of the imaging aperture 204. Thus, the imaging device 104 may be configured to automatically adjust its own configuration to optimally conform to a particular machine vision job. Additionally, the imaging device 104 may include or otherwise be adaptable to include, for example but without limitation, one or more bandpass filters, one or more polarizers, one or more waveplates, one or more DPM diffusers, one or more C-mount lenses, and/or one or more C-mount liquid lenses over or otherwise influencing the received illumination through the imaging aperture 204.

The user interface label 206 may include the dome switch/button 208 and one or more LEDs 210, and may thereby enable a variety of interactive and/or indicative features. Generally, the user interface label 206 may enable a user to trigger and/or tune to the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., dome switch/button 208) may enable a user to capture an image using the imaging device 104 and/or to display a trigger configuration screen of a user application (e.g., smart imaging application 116). The trigger configuration screen may allow the user to configure one or more triggers for the imaging device 104 that may be stored in memory (e.g., one or more memories 110, 120) for use in later developed machine vision jobs, as discussed herein.

As another example, the tuning function of a dome switch/button (e.g., dome switch/button 208) may enable a user to automatically and/or manually adjust the configuration of the imaging device 104 in accordance with a preferred/predetermined configuration and/or to display an imaging configuration screen of a user application (e.g., smart imaging application 116). The imaging configuration screen may allow the user to configure one or more configurations of the imaging device 104 (e.g., aperture size, exposure length, etc.) that may be stored in memory (e.g., one or more memories 110, 120) for use in later developed machine vision jobs, as discussed herein.

To further this example, and as discussed further herein, a user may utilize the imaging configuration screen (or more generally, the smart imaging application 116) to establish two or more configurations of imaging settings for the imaging device 104. The user may then save these two or more configurations of imaging settings as part of a machine vision job that is then transmitted to the imaging device 104 in a job file containing one or more job scripts. The one or more job scripts may then instruct the imaging device 104 processors (e.g., one or more processors 118) to automatically and sequentially adjust the imaging settings of the imaging device in accordance with one or more of the two or more configurations of imaging settings after each successive image capture.

The mounting point(s) 212 may enable a user connecting and/or removably affixing the imaging device 104 to a mounting device (e.g., imaging tripod, camera mount, etc.), a structural surface (e.g., a warehouse wall, a warehouse ceiling, scanning bed or table, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 212 may enable a user to connect the imaging device 104 to a myriad of accessory items including, but without limitation, one or more external illumination devices, one or more mounting devices/brackets, and the like.

In addition, the imaging device 104 may include several hardware components contained within the housing 202 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

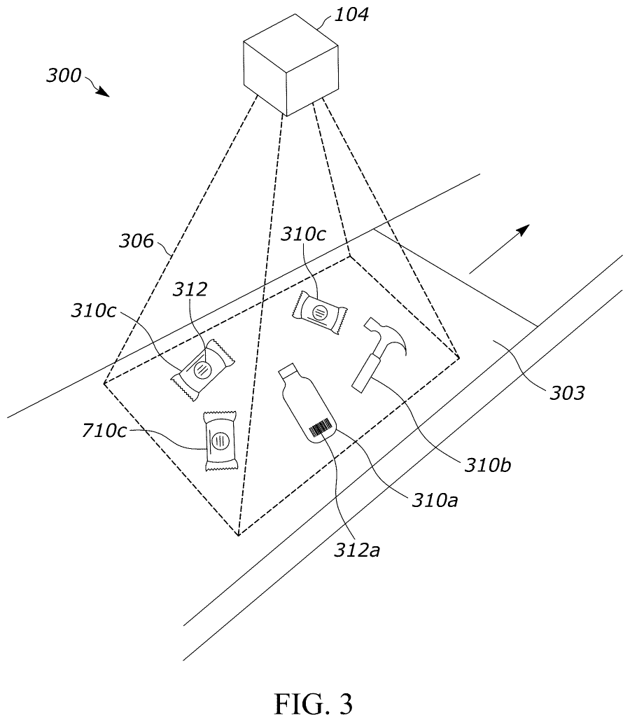

FIG. 3 illustrates an example environment 300 for performing machine vision scanning of an object as described herein. In the environment 300 of FIG. 3 the imaging device 104 of FIGS. 1 and 2 is position above a scanning surface 303. The imaging device 104 is disposed and oriented such that a field of view (FOV) 306 of the imaging device 104 includes a portion of the scanning surface 303. The scanning surface may be a table, podium, mount for mounting an object or part, a conveyer, a cubby hole, or another mount or surface that may support a part or object to be scanned. As illustrated, the scanning surface 303 is a conveyer belt having a plurality of objects of interest 310a, 310b, and 310c thereon. The objects of interested 310a-310c are illustrated as being within the FOV 306 of the imaging device 104. The objects of interest 310a-310c may contain indicia 312 thereon. The imaging device 104 captures one or more images of the objects of interest 310a-310c and may determine a region of interest within the image that contains the objects of interest 310a-310c, or the ROI may be determined as a region of the image that contains the indicia 312. As illustrated, the indicia 312 may be a barcode, but the indicia 312 may include one or more of 1D barcode, 2D barcode, QR code, static barcode, dynamic barcode, alphabetical character, text, numerals, alphanumeric, other characters, a picture, vehicle identification number, expiration date, tire identification number, or another indicia having characters and/or numerals. In examples, the objects of interest 310a-310c may have more than one indicia, and the imaging device 104 may capture an image of the FOV 306 and determine multiple ROIs in the captured image, each ROI having at least one indicia for decoding.

The imaging device 104 may determine one or more surfaces of each of the objects of interest 310a-310c for performing surface matching. The imaging device 104, and associated system 100, may identify, from 3D information from a 3D image or point cloud, a curved surface of one of the objects of interest 310a-310c such as a curved outer surface of a bottle (e.g., object of interest 310a) or a curved surface of a handle of a hammer (e.g., object of interest 310b). The imaging device 104, and associated processors and system 100, may then match the identified curved surface with a model surface to further perform surface matching. The system 100 may then identify that the curved surface is part of a bottle if the curved surface is matched to a model surface of a bottle. Otherwise, the system may match the identified curved surface to a curved surface of model surface of a hammer handle, other the system may match the identified curved surface to another model surface of an object. The system 100 may identify one or more surfaces having ridged features such as on a packet (e.g., object of interest 310c) generally having a ridged edge or surface. As such, the system 100 may then match multiple surfaces of different objects of interest 310c to a model surface having a ridged edge. In typical surface matching systems, the system would not be able to distinguish between the different objects of interest 310c due to the limitations of only using geometric information for performing the surface matching. Therefore, the system could not distinguish between a packet of screws and a packet of candy. The described systems further can determine differences between the surfaces of the objects of interest 310c by analyzing color information associated the surfaces of the objects of interest 310c and comparing the color information to a color model, or color information associated with a model surface.

The imaging device 104 may be mounted above the object of interest 310 on a ceiling, a beam, a metal tripod, or another object for supporting the position of the imaging device 104 for capturing images of the scanning surface 303. Further, the imaging device 104 may alternatively be mounted on a wall or another mount that faces objects on the scanning surface 303 from a horizontal direction. In examples, the imaging device 104 may be mounted on any apparatus or surface for imaging and scanning objects of interest that are in, or pass through, the FOV 306 of the imaging device 104.

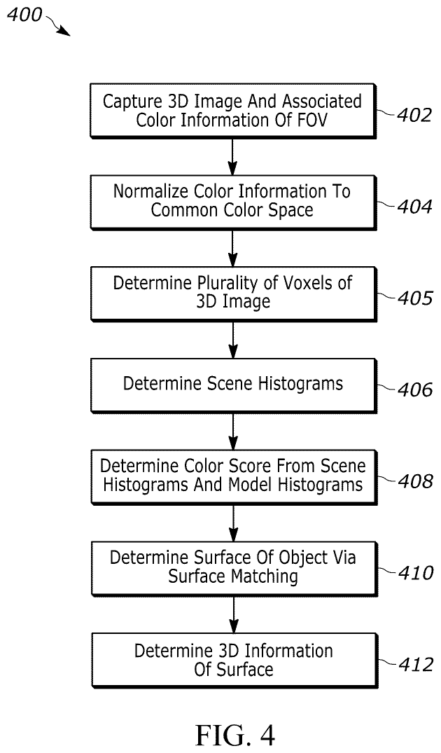

The described method and system may be implemented for identifying surfaces of objects and matching the surfaces of objects to model surfaces for identifying surfaces and objects using both geometric and color information of a FOV of a camera. FIG. 4 illustrates a flowchart for a method of performing 3D surface matching using color information. The method of FIG. 4 may be implemented using the system 100 of FIG. 1, and the imaging devices 104 of FIGS. 1 through 3. A process 400 begins at block 402 with an imaging sensor capturing 3D image data, also referred to herein as a 3D image, of a FOV of the imaging sensor. The imaging sensor includes one or more cameras for obtaining 3D image data of the FOV of the imaging sensor. For example, the imaging sensor may include one or more of a time-of-flight camera, a stereo vision camera, a structured light camera, a range camera, a 3D profile sensor, a triangulation imager, or another imaging camera or system capable of capturing or deriving 3D information from. While described as capturing a 3D image, the imaging sensor may capture one or more 2D images and further determine or compose a 3D image from the one or more 2D images. Additionally, the imaging sensor may capture a point could as the 3D image, or a set of voxels as the 3D image. In examples, the 3D image includes any set of data that includes 3D information of the FOV of the imaging sensor. The captured image data includes 3D information which may include a plurality of voxels and/or a plurality of 3D points of the FOV, and further, the image data includes color information of the FOV. The color information may include color information for each voxel or 3D point of the respective plurality of voxels or plurality of 3D points. In other examples, the 3D information may include a plurality of points in 3D space and with an associated color at each respective point. Additionally, voxels and/or spatial points may be absent of color (e.g., in air or free space) and a null value or 0 value may be assigned for the color for such voxels or points.

At block 404, a processor normalizes the color information into a common color space. For example, the processor may receive color data or information in any format and normalize the color information or data into lab color space or hue, saturation, lightness (HSL) color space, OKHSL color space, and normalized RGB color space, among others. In examples, the color information may include one or more color images that the processor normalized into a given color space. Additionally, the color information may include RGB values for pixels or voxels of the 3D image, and the color information may be gamma corrected or not based entirely on camera settings in certain examples. The processor determines a plurality of voxels of the 3D image at block 405. Each voxel is determined from 3D information of the FOV of the imaging sensor, and each voxel includes one or more 3D points of the image of the FOV of the imaging sensor.

At block 406, the processor determines a plurality of scene histograms from the normalized color information. Each scene histogram of the plurality of scene histograms is determined for a given voxel of the plurality of voxels of the 3D image. For example, a voxel may include a surface having colors thereon, and the scene histogram for the given voxel is a histogram of the color information contained within the given voxel. The histogram may be a histogram of RGB values from 0 to 255. In examples, the histogram is a histogram per voxel which is a histogram that is a function of normalized color components, such as three different normalized color components. Each histogram is localized per voxel to have a local color matching of a surface in the voxel. As such, each histogram is a function the color distribution of a surface for a given voxel.

At block 408, the processor compares the plurality of scene histograms of the obtained 3D image with a plurality of model histograms and determines a color score from the plurality of scene histograms and the plurality of model histograms. The model histograms are a set of color distribution histograms indicative of the colors of a model surface. Each model histogram of the plurality of model histograms is indicative of a color profile or color distribution for a voxel of a model surface. The model histograms may be derived from color information and associated 3D information from one or more images of a model surface. The model histograms may include one or more RGB histograms ranging from 0-255 for each voxel of the 3D image of the model surface. Therefore, there may be multiple color model histograms associated with a single voxel to adequately capture the color information of a model surface for performing surface matching using color information.

At block 410, the processor determines the presence of a surface of an object in the obtained 3D image from the color score. To determine the presence of the surface in the 3D image, the processor may compare the color score to a threshold score. For example, the color score may be derived as a percent match between the plurality of scene histograms and the plurality of model histograms. In such an example, it may be determined that a color score below a threshold of 70% is not indicative of a surface match between a surface in the obtained 3D image and a model surface, whereas a color score of 70% or higher indicated a surface match and the presence of a matched model surface in the obtained 3D image. In examples, the color score may be on any scale indicative of a match between the plurality of scene histograms and plurality of model histograms. Additionally, the threshold score may be tuned to provide a desired surface matching performance efficiency for a given imaging system and for a given surface. For example, a higher threshold score value may require higher resolution imaging systems to perform efficiently, while surfaces with less features may allow for a lower threshold score value while maintaining a high surface match efficiency. The various optical and physical parameters may affect the desired threshold score for a given system, surface, or object.

In implementations, a plurality of objects may be present in the obtained image for the FOV of the imaging sensor. In such instances, the processor may compare the plurality of scene histograms to a library of different pluralities of model histograms, referred to herein as sets of histograms. Each set of histograms is indicative of a different surface or an object, or different surfaces of different objects. For example, one set of histograms may be indicative of the color distribution of the handle of a hammer, while another set of histograms may be indicative of the color distribution of the head of a hammer. Further, one set of histograms may be indicative of the color distribution on a packet of screws, while another set of histograms may be indicative of the color distribution of a packet of candy. The processor may determine a plurality of color scores, each color score corresponding to a respective comparison of the plurality of scene histograms with each set of model histograms. As a result, each color score is indicative of how closely matched surfaces of the obtained 3D image are with the various surfaces represented by the sets of model histograms. The processor may then determine the presence of a single surface from a highest color score, or the processor may determine the presence of multiple surfaces, of the model surfaces, in the obtained 3D image from the plurality of color scores.

Once the surface has been identified in the obtained 3D image, at block 412, the processor may then determine 3D information pertaining to the surface. For example, the processor may determine an orientation, size, a defect of the surface, identify the location of specific features of the surface etc. Additionally, the surface matching described may be used for detecting and identifying defects on or in the surface, and may further be used for quality control purposes in general. Additionally, the processor may determine one or more normal vectors of the surface which may further be used in image processing, machine vision, or to guide machinery as to the relative position and orientation of the surface or of an object associated with the surface.

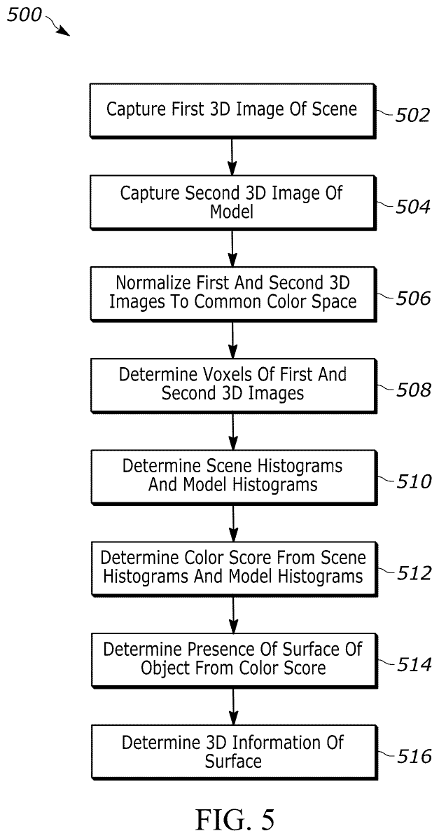

FIG. 5 illustrates a flowchart of another method for performing 3D surface matching using geometric and color information. The method of FIG. 5 may be implemented using the system 100 of FIG. 1, and the imaging devices 104 of FIGS. 1 through 3. A process 500 begins at block 502 with an imaging sensor capturing first 3D image data, also referred to herein as a first 3D image, scene image, or image of the scene, of a scene in the FOV of the imaging sensor. At block 504, the imaging sensor captures second 3D image data, also referred to herein as a second 3D image, model image, or image of model, of a model surface or a model object in the FOV of the imaging sensor. The model surface or model object is a surface or object for performing surface matching to the model surface. The model surface may be used to perform surface matching of the first image to determine if a surface similar to, or the same as, the model surface is present in the first 3D image.

The imaging sensor includes one or more cameras for obtaining 3D image data of the FOV of the imaging sensor. For example, the imaging sensor may include one or more of a time-of-flight camera, a stereo vision camera, a structured light camera, a range camera, a 3D profile sensor, a triangulation imager, or another imaging camera or system capable of capturing or deriving 3D information from. While described as capturing a 3D image, the imaging sensor may capture one or more 2D images and further determine or compose a 3D image from the one or more 2D images. Additionally, the imaging sensor may capture a point could as a 3D image, or a set of voxels as a 3D image. In examples, the 3D image includes any set of data that includes 3D information of the FOV of the imaging sensor. The processor may further determine voxels of the first 3D image and/or the second 3D image from 3D points obtained by the imaging sensor.

At block 506, a processor normalizes color information of the first and second images into a common color space. For example, the processor may receive color data or information in any format and normalize the color information or data into lab color space or hue, saturation, lightness (HSL) color space, normalized RGB color space, OKHSL color space, or another color space. In examples, the color information may include one or more color images that the processor normalized into a given color space. Additionally, the color information may include RGB values for pixels or voxels of the 3D image, gamma corrected values, or another type of color information. In any examples, the color information of the first and second images is normalized and/or converted to a common same color space for further processing and comparison.

At a block 508, the processor determines a plurality of voxels of the first 3D image, and a plurality of voxels of the second 3D image. The voxels may be determined according to a point of reference in each image such as a given orientation of the image, or the voxels may be determined solely by the FOV of the imaging sensor such as predefined voxels or regions of the FOV of the imaging sensor.

After the voxels have been determined for the first and second 3D images, the processor may determine corresponding voxels between the first and second 3D images. For example, by using a geometric surface matching technique or algorithm to match the surface shapes. The processor may determine one or more normal vectors of a surface in one or more voxels and use the determined normal vectors to perform surface matching to match an imaged surface with a model surface having known or predetermined normal vectors. To determine the corresponding voxels, the processor may perform one or more 3D transformations on the first 3D image, the second 3D image, voxels of the first 3D image, and voxels of the second 3D image.

At block 510, the processor determines a plurality of scene histograms from the normalized color information of the first 3D image, and a plurality of model histograms from the normalized color information of the second 3D image. Each scene histogram of the plurality of scene histograms is determined for a given voxel of the plurality of voxels of the 3D image. In examples, multiple histograms may be determined for each voxel. For example, a red histogram, blue histogram, and green histogram may be determined for each voxel to adequately represent the color distribution for each voxel. Each model histogram is indicative of the color distribution of a voxel of the second 3D image.

At block 512, the processor compares the plurality of scene histograms of the first 3D image with the plurality of model histograms of the second 3D image and determines a color score from the plurality of scene histograms and the plurality of model histograms. The color score may be determined using histogram comparisons such as color histogram intersection, or by determining histogram distances (e.g., the earth mover's distance), or may be determined by another technique based on the histograms. The color score is indicative of a rate of similarity or matching between the plurality of scene histograms and the plurality of model histograms.

At block 514, the processor determines the presence of a surface of an object in the first 3D image from the color score. The determined present surface in the first 3D image is a similar surface or a same type of surface as the model surface or model object. To determine the presence of the surface in the first 3D image, the processor may compare the color score to a threshold score. In examples, the color score may be on any scale indicative of a match between the plurality of scene histograms and plurality of model histograms. Additionally, the threshold score may be tuned to provide a desired surface matching performance efficiency for a given imaging system and for a given surface. For example, a higher threshold score value may require higher resolution imaging systems to perform efficiently, while surfaces with less features may allow for a lower threshold score value while maintaining a high surface match efficiency. The various optical and physical parameters may affect the desired threshold score to perform surface matching with a certain level of efficiency for a given system, surface, or object.

Once the surface has been identified in the first 3D image, at block 516, the processor may then determine 3D information pertaining to the identified surface. For example, the processor may determine an orientation, size, location, position, or perform object detection or defect detection. Additionally, the processor may determine one or more normal vectors of the identified surface which may further be used in image processing, machine vision, or to guide machinery as to the relative position and orientation of the surface or of an object associated with the surface.

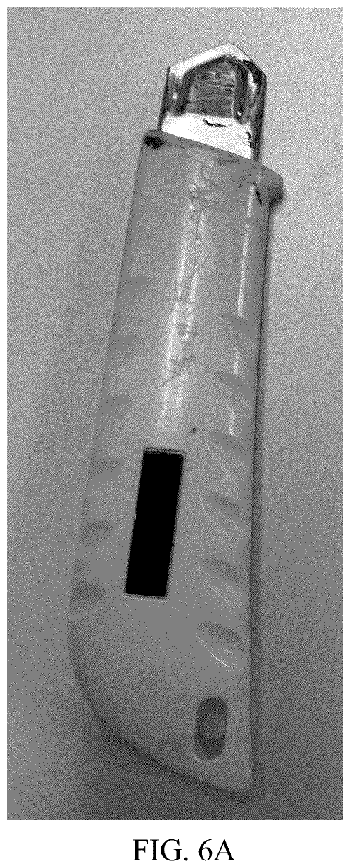

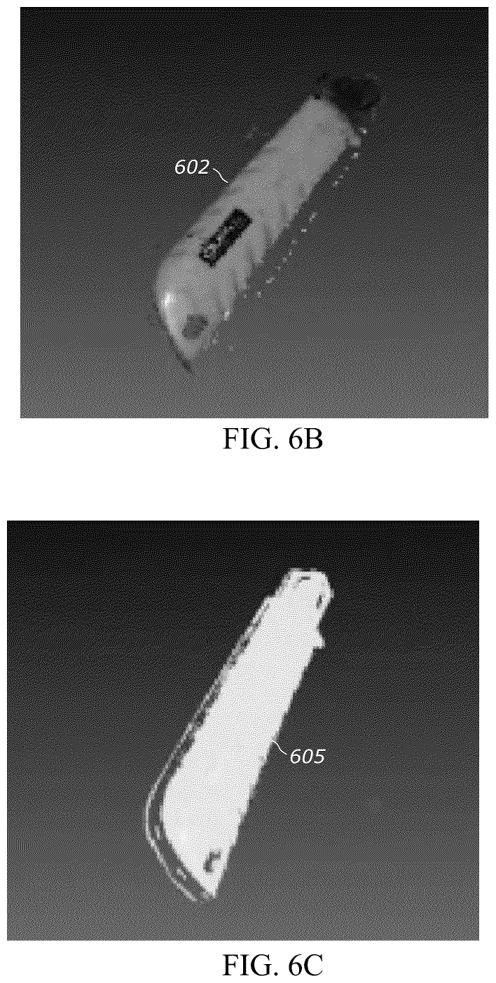

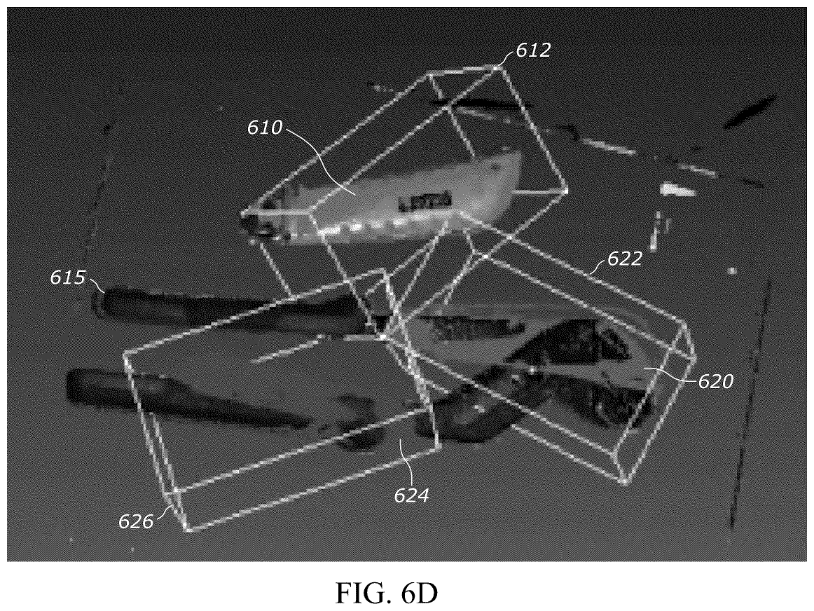

FIGS. 6A through 6D are images demonstrating an example of performing 3D surface matching without using color information, as may be performed by typical surface matching systems. FIG. 6A is an image of a model object being a cutter for demonstrating performing 3D surface matching using geometric and color information, in accordance with embodiments described herein. FIG. 6B is an image of model surface 602 being a cutter, with the image of FIG. 6B captured by a 3D surface matching system. While described as a model surface 602, the model surface may be part of a larger or more complete object, and therefore, may be referred to herein as a model object or part of a model object. The geometric information of the model surface 602 is used to identify a plurality of voxels and generate a 3D model of the model surface 602. FIG. 6C is an image showing the determined 3D geometric model 605 of the model surface 602.

FIG. 6D is an image of multiple objects in a FOV of an imaging sensor. Surface matching using the 3D geometric model 605 of the model surface 602 is performed on the image of FIG. 6D, and multiple surfaces are matched to the 3D geometric model 605 without using color information. The matched surfaces are indicated by cuboid structures indicating regions containing each matched surface. A first surface 610 in first region 612 is correctly matched as a same, or similar surface, to the 3D geometric model 605 of the model surface 602. Two additional, incorrect, surfaces are also identified as matching the model surface 602. In addition to the first surface 610 in the first region 612, a set of pliers 615 is also present in the FOV of the imaging sensor and multiple surfaces on the pliers 615 are matched with the 3D geometric model 605 of the model surface 602. For example, a first portion 624 of the plier handle in second region 626 is incorrectly matched with the model surface 602, and a portion of the plier jaws 620 are also incorrectly matched with the model surface 602 in a region 622 of the image. Therefore, two erroneous surfaces were matched in addition to a single correct surface matching operation in the example of FIGS. 6A through 6D.

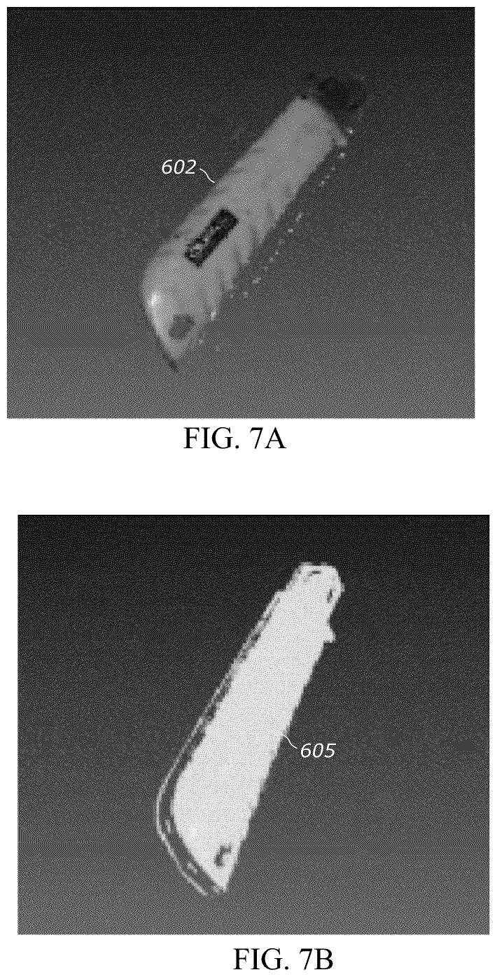

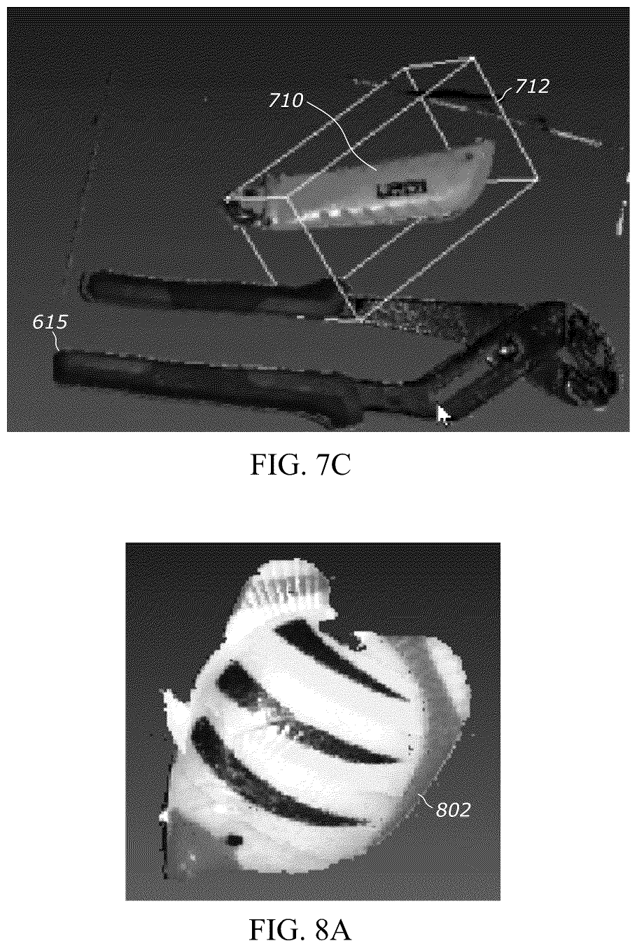

FIGS. 7A through 7C are images demonstrating an example of performing 3D surface matching using color information, as described herein. FIG. 7A is an image of the same model surface 602 of FIGS. 6A-6D, and FIG. 7B is an image of the determined 3D geometric model 605 of the model surface 602. FIG. 7C is an image of surfaces matched to the model surface 602 using the 3D geometric model 605 and associated color information (e.g., color histograms and a color score as described with reference to the flow diagrams of FIGS. 4 and 5). Further using the color information allowed for proper identification of the matched surface 710 in region 712 of FIG. 7C. No other surfaces were matched in FIG. 7C showing an improvement in the accuracy of the surface matching when color information is used in addition to the 3D geometric information. As evidenced by the results of FIG. 7C, including the color information in the surface matching process reduced erroneous surface matches from two to zero in this instance. It is envisioned that the benefits of performing 3D surface matching using color information is further increased as more objects and surfaces are presented in a given image or sets of images.

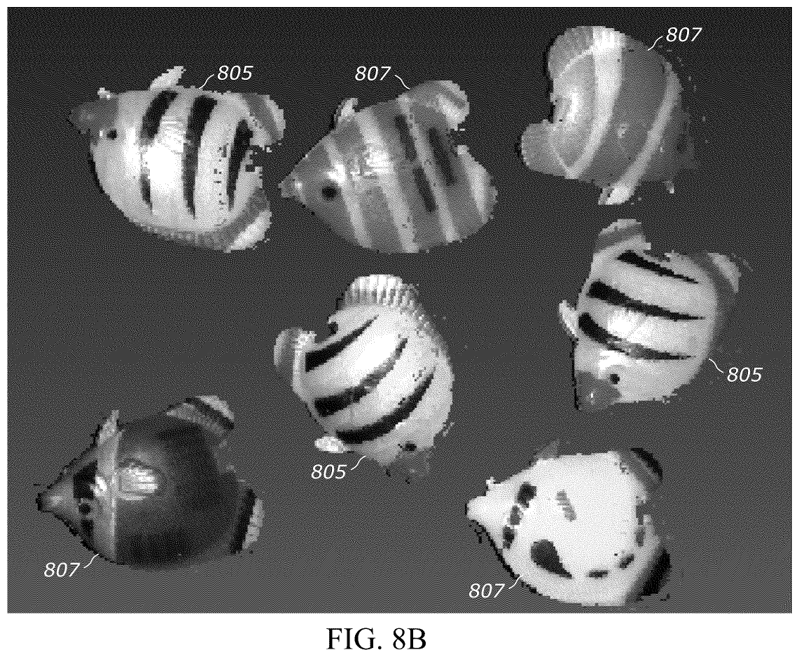

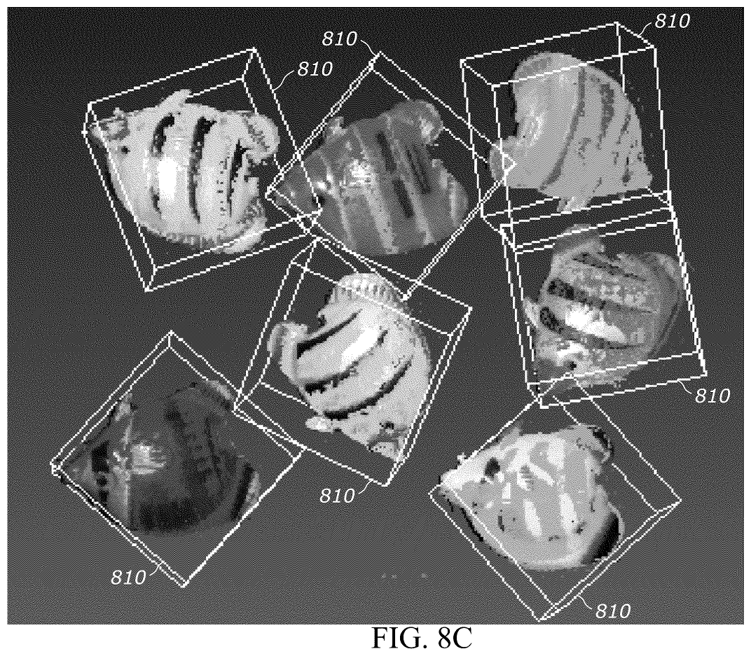

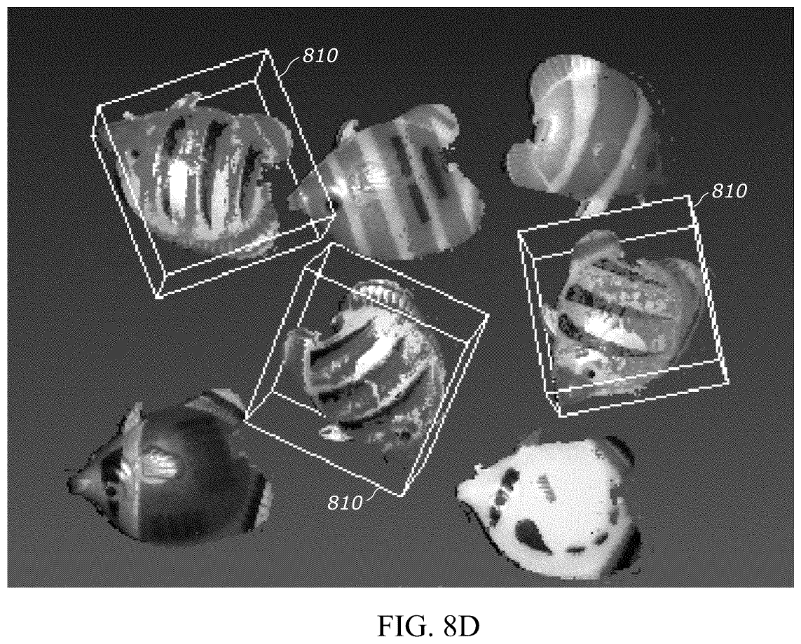

FIGS. 8A through 8D are images illustrative of performing 3D surface matching using color information. FIG. 8A is an image of a model surface 802 being a surface of a fish with a given color distribution including a yellow and black color pattern and blue fins. FIG. 8B is an image of a plurality of fish with similar or same geometric information as the model surface 802, but with varied color distributions and color patterns. FIG. 8B includes three matches 805, also referred to herein as matching surfaces or matching copies, to the model surface 802, and four non-matches 807, also referred to herein as non-matching surfaces or non-matching objects. Each of the non-matches 807 has a different color profile, color patterns, and overall color distribution that the model surface 802.

FIG. 8C is an image of a surface matching operation that does not use color information in performing the surface matching. The surface matching operation shown in FIG. 8C identified each of the matches 805 and erroneously identified each of the non-matches 807 as matching the model surface 802, indicated by the cuboid frames 810 surrounding each of the matches 805 and non-matches 807. This is expected as each of the objects presented in FIGS. 8B and 8C has a same/similar surface shape and features as the model surface 802. Therefore, without the color information, the surface matching will identify each of the non-matches 807 as matching the model surface 802.

FIG. 8D is an image of a surface matching operation that includes using color information in performing surface matching. Each of the matches 805 are properly identified as matching the model surface 802, as indicated by the cuboid frames 810, and none of the non-matches 807 are flagged or identified as matching the model surface 802. The results of FIGS. 8A through 8D show the increased accuracy of the methods and systems described herein. Using color information in performing 3D surface matching allows for reduced errors, more robust surface identification abilities, and further reduces or removes the need for user intervention in verifying accuracy of matched surfaces.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for performing three-dimensional surface matching, the method comprising:
obtaining, by a three-dimensional (3D) camera, a first 3D image of a field of view of the 3D camera, the first 3D image including (i) a plurality of 3D points of the field of view and (ii) color information of the field of view;
normalizing, via a processor, the color information into a common color space;
determining, by the processor, a plurality of voxels of the 3D image, each voxel including one or more of the 3D points of the plurality of 3D points;
determining, via the processor, scene histograms from the normalized color information of the first 3D image, each of the scene histograms determined for a voxel of the plurality of voxels of the first 3D image;
determining, via the processor, a color score from at least the scene histograms and model histograms, the model histograms being indicative of color information of a model image of a 3D object; and
determining, via the processor, the presence of a surface of an object in the first 3D image from the color score.

2. The method of claim 1, wherein normalizing the first 3D image into a common color space comprises converting the first 3D image into lab color space or hue, saturation, lightness (HSL) color space.

3. The method of claim 1, wherein determining the scene histograms comprises determining a color histogram for each voxel of the first 3D image.

4. The method of claim 1, wherein determining the color score comprises:
identifying, via the processor, sets of corresponding voxels between the voxels of the first 3D image, and voxels of the model image;
determining, via the processor, a comparison score for each set of corresponding voxels; and
determining, via the processor, the color score as a weighted sum of the comparison scores.

5. The method of claim 4, wherein identifying sets of corresponding voxels comprises performing a 3D transformation on at least one of the first 3D image or the model image.

6. The method of claim 1, wherein determining the presence of the surface of the object comprises determining, via the processor, the presence of the surface by comparing the color score to a threshold score.

7. The method of claim 1, further comprising:
obtaining, by a 3D camera, a second 3D image of a model object, the second 3D image including (i) 3D spatial information of the model object and (ii) color information associated with the model object;
normalizing, via a processor, the color information associated with the model object into a common color space;
determining, via the processor, voxels of the second 3D image from the 3D spatial information of the model object; and
determining, via the processor, the model color histograms from the voxels of the second 3D image and the normalized color information associated with the model object.

8. The method of claim 1, further comprising determining, via the processor, 3D information pertaining to one or more surfaces of the object in the first 3D image.

9. The method of claim 1, further comprising determining, via the processor, one or more normal vectors of the surface of the object in the first 3D image.

10. A system for performing surface matching, the system comprising:
a 3D imager configured to capture and provide 3D images of a field of view of the 3D imager, the 3D images including (i) a plurality of 3D points of the field of view and (ii) color information of the field of view; and
a processor and computer-readable media storage having machine readable instructions stored thereon that, when the machine readable instructions are executed, cause the system to:
obtain a first 3D image of the field of view of the 3D imager;
normalize color information of the first 3D image into a common color space;
determine, by the processor, a plurality of voxels of the 3D image, each voxel including one or more of the 3D points of the plurality of 3D points;
determine scene histograms from the normalized color information of the first 3D image, each of the scene color histograms determined for a voxel in the first 3D image;
determine a color score from at least the scene histograms and model histograms, the model histograms being indicative of color information of a model image of a 3D object; and
determine the presence of a surface of an object in the first 3D image from the color score.

11. The system of claim 10, wherein to normalize the color information into a common color space, the machine readable instructions further cause the system to convert the color information of the first 3D image into lab color space or hue, saturation, lightness (HSL) color space.

12. The system of claim 10, wherein to determine the scene histograms, the machine readable instructions further cause the system to determine a color histogram for each voxel of the first 3D image.

13. The system of claim 10, wherein to determine the color score, the machine readable instructions further cause the system to:
identify sets of corresponding voxels between the voxels of the first 3D image, and voxels of the model image;
determine a comparison score for each set of corresponding voxels; and
determine the color score as a weighted sum of the comparison scores.

14. The system of claim 13, wherein to identify sets of corresponding voxels, the machine readable instructions further cause the system to perform a 3D transformation on at least one of the first color image or the model image.

15. The system of claim 10, wherein to determine the presence of the object, the machine readable instructions further cause the system to determine the presence of the object by comparing the color score to a threshold score.

16. The system of claim 10, wherein the machine readable instructions further cause the system to:
obtain a second 3D image of a model object, the second 3D image including (i) 3D spatial information of the model object and (ii) color information associated with the model object;
normalize the color information associated with the model object into a common color space;
determine voxels of the second 3D image from the 3D spatial information of the model object; and
determine the model histograms from the voxels of the second 3D image and the normalized color information associated with the model object.

17. The system of claim 10, wherein the machine readable instructions further cause the system to determine 3D information pertaining to one or more surfaces of the object in the first 3D image.

18. The system of claim 10, wherein the 3D imager comprises at least one of a time of flight camera, stereo vision camera, structured light camera, a range camera, a 3D profile sensor, an a triangulation 3D imager.

19. One or more non-transitory computer-readable media storing computer-executable instructions that, when executed via one or more processors, cause one or more imaging systems to:
obtain, via a 3D camera, a first 3D image of a field of view of the 3D camera, the first 3D image including (i) 3D spatial information and (ii) color information of the field of view;
normalize, via a processor, the color information into a common color space to form normalized color information;
determine, via the processor, a plurality of voxels of the 3D image, each voxel including one or more of the 3D points of the plurality of 3D points;
determine, via the processor, scene color histograms from the normalized color information of the first 3D image, each of the scene color histograms determined for a voxel in the first 3D image;
determine, via the processor, a color score from at least the scene color histograms and model color histograms, the model color histograms being indicative of color information of a model image of a three-dimensional object; and
determine, via the processor, the presence of a surface of an object in the first 3D image from the color score.
